(19) United States
(12) Patent Application Publication
(10) Pub. No.: US 2006/0008174 A1
(43) Pub. Date: Jan. 12, 2006

(54) COUNT ADAPTIVE NOISE REDUCTION METHOD OF X-RAY IMAGES

(75) Inventors: Gopal B. Avinash, New Berlin, WI (US); Nicholas L. Marinelli, Wauwatosa, WI (US); Kadri N. Jabri, Waukesha, WI (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY, Waukesha, WI (US)

(21) Appl. No.: 10/710,391

(22) Filed: Jul. 7, 2004

(51) Int. Cl. G06K 9/40

(52) U.S. Cl. 382/275

(57) ABSTRACT

A method of adaptively reducing noise within an x-ray image includes receiving raw data (R) representing a detected x-ray signal from an object. A counts-based modulation mask (M_{cb}) is generated in response to the raw data (R). In one embodiment, a structure dependent noise filtered image (I_{blended}) is generated in response to the raw data. A noise-reduced image (I_{F}) is generated in response to the counts-based modulation mask (M_{cb}) and the structure dependent noise filtered image (I_{blended}). In another embodiment, a structure gradient mask (M_{cs}) is generated in response to the raw data (R). The noise-reduced image (I_{F}) is generated in response to the counts-based modulation mask (M_{cb}) and the structure gradient mask (M_{cs}).

### BACKGROUND OF INVENTION

The present invention relates generally to x-ray imaging systems. More particularly, the present invention relates to the reduction of noise within x-ray images at highly attenuated regions without affecting image contrast at relatively low attenuated regions.

Many techniques are known and are presently in use for the generation of digital image data. Such techniques range from the use of simple charge coupled device apparatuses, such as digital cameras, to more complex imaging systems, such as those used for part inspection and medical diagnostics purposes. The stated systems, in general, form a matrix of discrete picture elements or pixels that have individual values over a range of intensities. Raw image data acquired by the stated systems may be processed to clarify an image, to enhance image features, or to improve the image quality from various points of view. In general, the goal of image enhancement and quality improvement is to provide useful images that provide desired information for a user.

In the medical imaging context a number of imaging modalities are employed. Within the imaging modalities a scanner or other image acquisition system is typically used to acquire raw image data, which is then processed to form a useful set of data for image reconstruction and viewing. The raw data typically contains noise and must be processed to provide clear and useful images for evaluation.

Noise may result from a wide variety of sources, typically from the various components used to acquire the image data, but may also be a function of the physics of a system and the nature of the subject being imaged. Noise may be a mixture of random point noise, sometimes referred to as spike noise, and patterned noise. Modalities such as x-ray imaging and optical imaging, where image data is directly acquired, exhibit such noise in a readily visible manner. However, imaging methods requiring image reconstruction, such as MRI, CT, and ultrasound, convert point or spike noise into splotches or small streaks that are usually hidden with the patterned noise. It is desirable that the point noise and the patterned noise be detected and appropriately mitigated. Unfortunately, current methods designed to mitigate patterned noise do not adequately mitigate point noise without blurring or decreasing the contrast of the useful information in the processed image.

During the display processing of the x-ray images, the image noise at highly attenuated regions in the images becomes more noticeable, and can therefore decrease the perceived quality of the final images. This perceived image degradation is mainly due to the contrast enhancement that occurs in the highly attenuated regions of the image. Currently, noise reduction techniques based on image properties alone can improve the perceived quality of highly attenuated regions of such images. However, this noise reduction decreases the contrast at lowly attenuated regions of the images, such as in lung parenchyma regions.

In the filtering and/or processing of the images it is generally desirable to filter areas of an image with low counts heavily and areas with high counts lightly. The term “counts” refers to the intensity level of a pixel representing a structure, such as a bone of a patient. This filtering provides a clearer view of the structures of interest. Some structures that are generally not desired for evaluation have such a low count that all that is visible on an image is noise; these structures are generally removed with the noise from the image. However, certain structures that are desired for evaluation and that have relatively low counts, such that they are partially visible, when heavily filtered are also undesirably removed from an image. The undesirably removed structures may be within the stated lung parenchyma regions or, as another example, within the jaw regions of a patient.

Thus, there exists a need for an improved filtering technique that improves the image quality, that reduces point noise and pattern noise, and that reduces noise in high attenuated regions of x-ray images, without affecting the image contrast at relatively low attenuated regions. It is also desirable that the technique account for detected signal properties in a noise reduction framework, where the framework is adaptive to the detected signal.

### SUMMARY OF INVENTION

The present invention provides methods and systems for adaptively reducing noise within an x-ray image. In one embodiment of the present invention, a method is provided that includes the receiving of raw data representing a detected x-ray signal from an object. A counts-based modulation mask is generated in response to the raw data. A structure dependent noise filtered image is generated in response to the raw data. A noise-reduced image is generated in response to the counts-based modulation mask and the structure dependent noise filtered image.

In another embodiment of the present invention, a similar method is provided that includes the receiving of raw data and the generation of a counts-based modulation mask, but rather includes the generation of a structure gradient mask in response to the raw data. Subsequent to the generation of a structure gradient mask, a noise-reduced image is generated in response to the counts-based modulation mask and the structure gradient mask.

The embodiments of the present invention provide several advantages. One such advantage is the provision of generating a noise reduced image that is structure dependent and count dependent. This dependency prevents the removal or filtering of at least somewhat visible structures with relatively low counts or pixel intensities.

Another advantage that is provided by an embodiment of the present invention is the provision of smoothing highly attenuated x-ray image regions more than relatively low attenuated regions. Noise reduction is performed while minimizing contrast degradation in high signal-to-noise regions of the x-ray images.

Yet another advantage provided by an embodiment of the present invention is the provision of performing limiting noise reduction in low signal-to-noise regions where significant structures are present, thus maintaining clinical detail.

A further advantage provided by an embodiment of the present invention is the provision of modulating smoothing in response to visually relevant structures and graininess pertaining to noise of the x-ray images. This aids in inadvertently filtering desired structure data.

Moreover, the embodiments of the present invention provide an adaptive filtering technique that is easily implemented, computationally efficient, and offers options for image enhancement and time optimization.

The present invention itself, together with attendant advantages, will be best understood by reference to the following detailed description, taken in conjunction with the accompanying figures.

### BRIEF DESCRIPTION OF DRAWINGS

For a more complete understanding of this invention reference should now be had to the embodiments illustrated in greater detail in the accompanying figures and described below by way of examples of the invention wherein:

FIG. 1 is a block schematic diagram of an x-ray system in accordance with an embodiment of the present invention;

FIG. 2 is a perspective and schematic diagram of a sample x-ray detector array;

FIG. 3 is a diagram illustrating an image having multiple structures and a corresponding pixel matrix;

FIG. 4 is a logic flow diagram illustrating a method of adaptively filtering x-ray image data in accordance with an embodiment of the present invention;

FIG. 5 is a plot of weights versus counts for received raw data collected by a detector operating at a standard dose sensitivity setting in accordance with an embodiment of the present invention;

FIG. 6 is a plot of weights versus counts for received raw data collected by a detector operating at a low dose sensitivity setting in accordance with an embodiment of the present invention;

FIG. 7 is a plot of count modulation curves utilized in the method of FIG. 4;

FIG. 8 is a logic flow diagram illustrating a method of performing a structure dependent smoothing filter operation within the method of FIG. 4;

FIG. 9 is a logic flow diagram illustrating a logic flow diagram illustrating a method of enhancing structural and non-structural regions in the method of FIG. 8;

FIG. 10 is a logic flow diagram illustrating a method of identifying structures in the blending operation of FIG. 9;

FIG. 11 is a gradient level masking plot in accordance with an embodiment of the present invention; and

FIG. 12 is a logic flow diagram illustrating a method of performing blending within the method of FIG. 4.

### DETAILED DESCRIPTION

In the following figures, the same reference numerals will be used to refer to the same components. While the present invention is described with respect to the reduction of noise within x-ray images of an x-ray system, the present invention is capable of being adapted for various purposes and is not limited to the following applications: computed tomography systems, radiotherapy or radiographic systems, x-ray imaging systems, ultrasound imaging systems, magnetic resonance imaging systems, positron emission tomography systems, electron beam imaging systems, tomosynthesis systems, and other applications known in the art.

In the following description, various operating parameters and components are described for one constructed embodiment. These specific parameters and components are included as examples and are not meant to be limiting.

Also, in the following description the term “mask” may refer to a “look-up” table, a conversion scale, a function, or the like. A mask may for example be in the form of a weighted curve that provides a value between zero and one depending upon one or more look-up parameters or input values. A mask may be in various forms and may have any number of inputs and corresponding outputs.

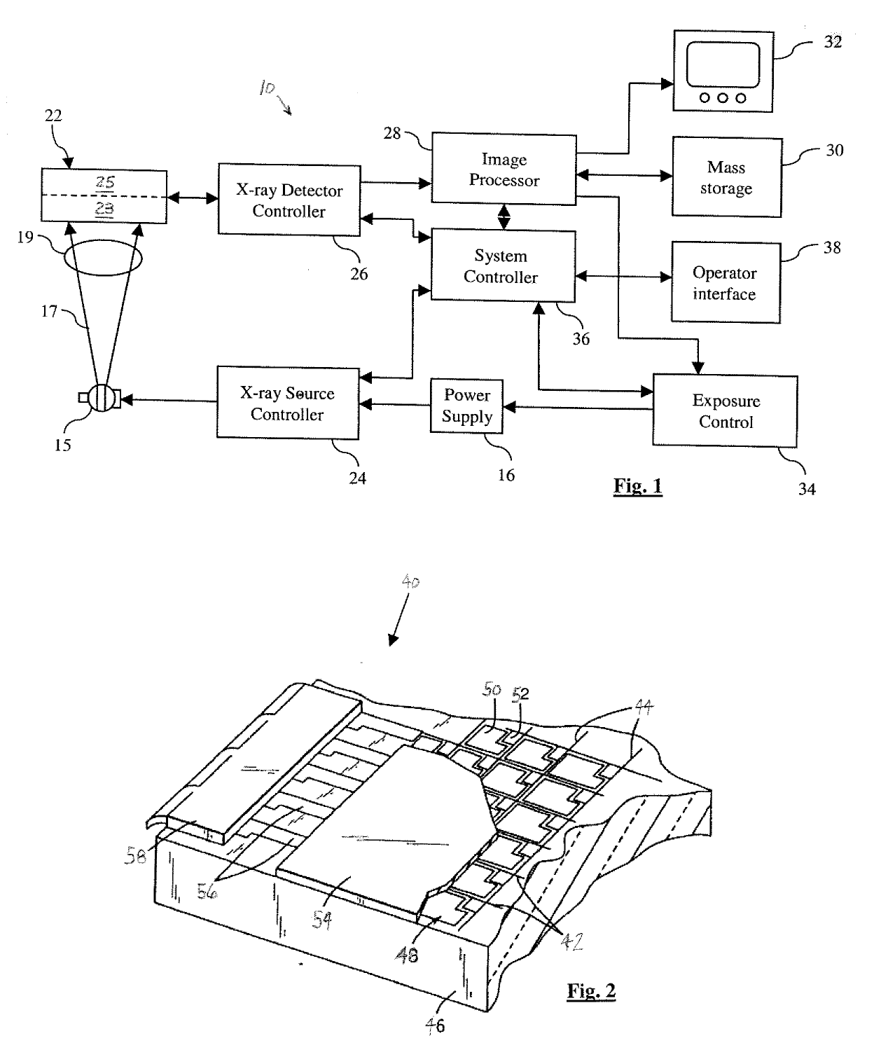

Referring now to FIG. 1, a block schematic diagram of an x-ray system 10 in accordance with an embodiment of the present invention is shown. The x-ray system 10 includes an x-ray source 15, an x-ray detector 22, an x-ray detector controller 26 that contains electronics for operating the x-ray detector 22, and an x-ray source controller 24 that contains electronics for operating the x-ray source 15. During operation, x-rays 17 are directed from the x-ray source 15 towards the x-ray detector 22, which may comprise a scintillator 23 and an amorphous silicon array 25. An overall system controller 36 provides power and timing signals to the x-ray source controller 24 and the x-ray detector controller 26, which then control the operation of the x-ray source 15 and x-ray detector 22, respectively. After passing through an object 19, such as a patient, the x-rays 17 impinge upon scintillator 23, which converts the x-ray photons therein to visible light. The visible light is then converted to an electrical charge. The x-ray detector controller 26 samples analog electrical charge data from the x-ray detector 22 and converts that analog data into digital signals. The digital signals are then sent to an image processor 28, where the image is processed and enhanced. The processed image or reconstructed image may then be viewed on a display 32, or other the like, and stored in a mass storage 30 for later retrieval.

The image processor 28 can also produce a brightness control signal that can be applied to an exposure control circuit 34 to regulate the power supply 16. The power supply 16 may thereby regulate the x-ray source 15 through x-ray source controller 24. The overall operation of the x-ray system 10 may be governed by a system controller 36, which may receive commands and/or scanning parameters from an operator via an input device or operator interface 38. The operator interface 38 may be in the form of a keyboard, a touch pad, or other suitable input device. The operator supplied commands and parameters may be used by the system controller 36 to provide control signals and information to the image processor 28, the x-ray detector controller 26, the x-ray source controller 24, and/or the exposure control circuit 34.

Referring now to FIG. 2, a perspective and schematic diagram of a sample x-ray detector array 40 is shown. The detector array 40 is an amorphous silicon flat panel x-ray detector that may be utilized in the embodiments of the present invention. Generally, column electrodes 42 and row electrodes 44 are disposed on a single piece glass substrate 46 that define an amorphous silicon array 48. The amorphous silicon array 48 comprises an array of photodiodes 50 and field effect transistors (FETs) 52. A scintillator 54 is disposed over the amorphous silicon array 48, and is optically coupled thereto. The scintillator 54, which may comprise a dose-efficient cesium iodide scintillator, receives and absorbs x-ray radiation during operation, and converts the x-ray photons therein to visible light. The high fill factor amorphous silicon array 48 converts the detected visible light into an electrical charge. Each photodiode 50 therein within the array 48 represents a pixel. The charge at each pixel is then read out and digitized by low-noise electronics, via contact fingers 56 and contact leads 58, and is thereafter sent to an image processor 28.

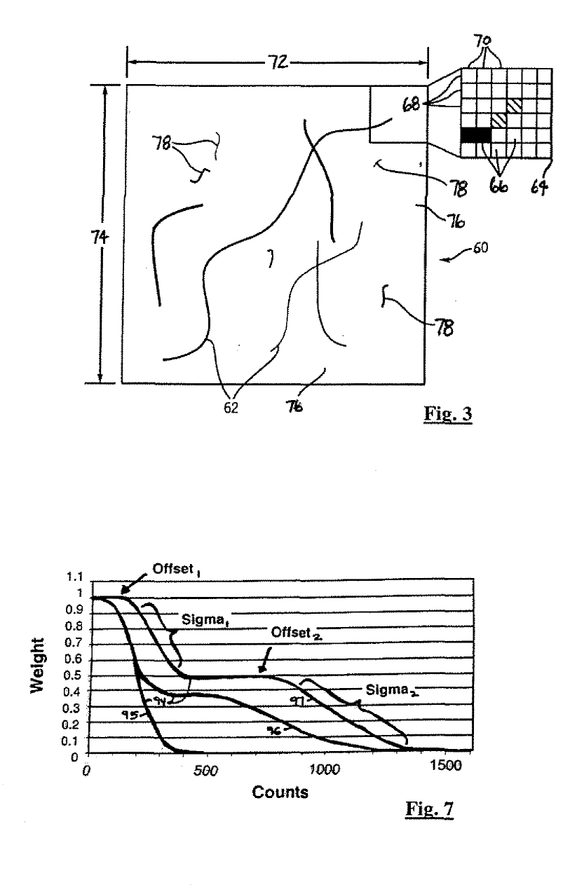

Referring now to FIG. 3, a diagram illustrating a pixel image 60 having multiple structures or structural regions 62 and a corresponding pixel matrix 64 is shown. The image 60 is composed of the matrix 64 of discrete pixels 66 disposed adjacent to one another in a series of rows 68 and columns 70. The rows 68 and columns 70 provide a pre-established matrix width 72 and matrix height 74. Typical matrix dimensions may include 256×256 pixels; 512×512 pixels; 1,024×1,024 pixels, and others. The particular image matrix size may be selected via the input device 38 and may vary depending upon such factors as the subject to be imaged and the resolution desired.

The image 60 includes the structural regions 62, illustrated as consisting of long, contiguous lines defined by adjacent pixels. The image 60 also includes non-structural regions 76 lying outside of the structural regions 62. The image 60 may also include isolated artifacts 78 of various sizes (i.e., number of adjacent pixels), which may be defined as structural regions, or which may be eliminated from the definition of structure in accordance with the techniques described below.

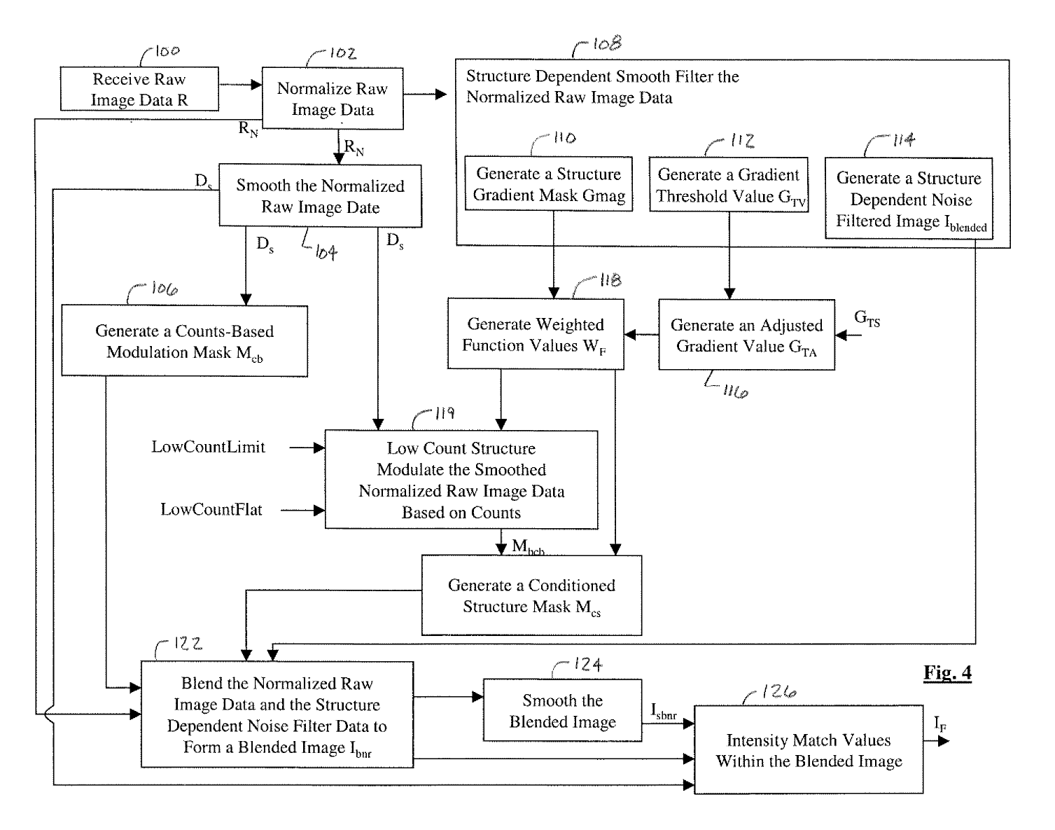

Referring now to FIG. 4, a logic flow diagram illustrating a method of adaptively filtering x-ray image data in accordance with an embodiment of the present invention is shown.

In step 100, raw image data R is received from the detector 22 by the image processor 28. In step 102, the image processor 28 normalizes the raw data R to generate normalized raw image data R_{N}. The gain of the detector 22 may be adjusted depending upon the data acquisition speed. The higher detect or speeds may have a lower corresponding detector gain than lower detector speeds.

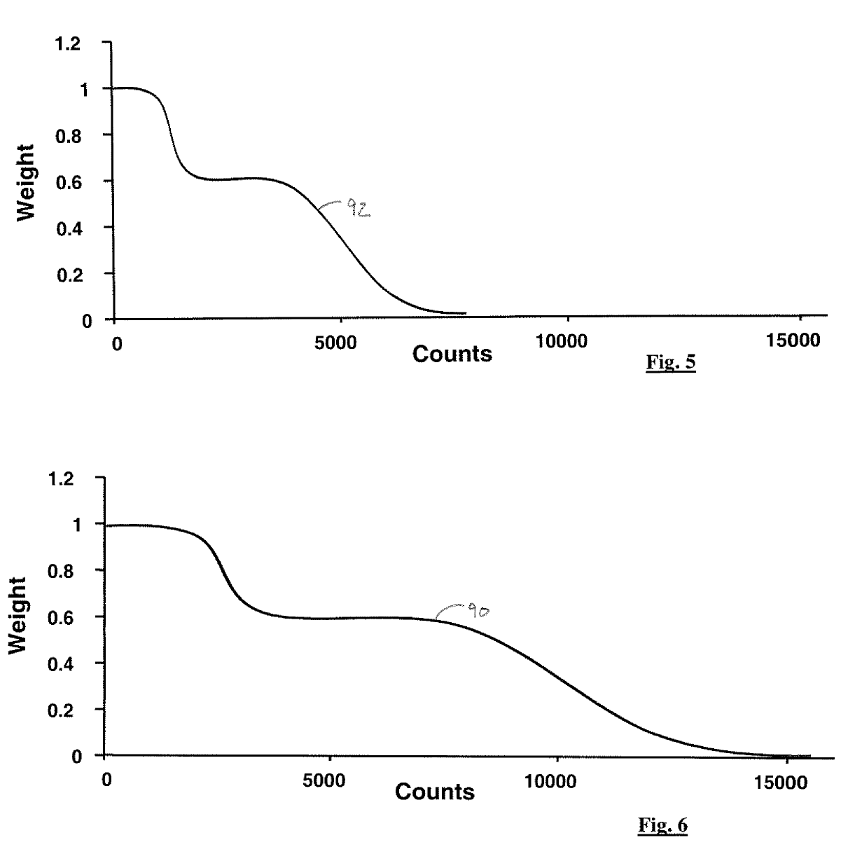

Referring now also to FIGS. 5 and 6, plots of weights versus counts for received raw data collected by a detector operating at a standard dose sensitivity setting or speed and operating at a low dose sensitivity setting or speed are shown. Note that the weight curve or look-up table 90 for the standard sensitivity is “stretched” such that the weight curve spans twice the number of counts as that for the weight curve 92 for the low sensitivity setting. The weight curve 90 is stretched by one over the ratio of the low dose sensitivity gain relative to the standard sensitivity gain, which in the provided example is equal to two.

In step 104, the normalized data R_{N} is smoothed to generate smoothed raw image data Dₛ. Local averaging of the normalized data R_{N} is performed using techniques known in the art. In step 106, a counts-based modulation mask M_{CB} is generated. The counts-based mask M_{CB} is generated using count modulation curves 94, some of which are shown in FIG. 7. The counts-based mask M_{CB} contains weighted values between zero and one. The counts-based mask M_{CB} includes weight values that are assigned each pixel location in response to absolute detected intensities or detected signal levels including the effects of imaging system gain at each pixel location. The count curves 94 are used to modulate the effect of image noise reduction in different regions of the image, without creating visible boundaries between the regions, and to simultaneously modulate smoothing based on visually relevant structures and graininess pertaining to noise.

The count curves 94 may include a low noise reduction curve 95, a medium noise reduction curve 96, and high noise reduction curve 97. The count curves 94 may include a primary offset segment with a constant weighting, a primary roll-off segment with a decreasing weighting, a secondary offset segment with a constant weighting, a secondary roll-off segment with a decreasing weighting, all of which are shown as part of the high noise reduction curve and denoted as Offset₁, Sigma₁, Offset ₂, and Sigma₂.

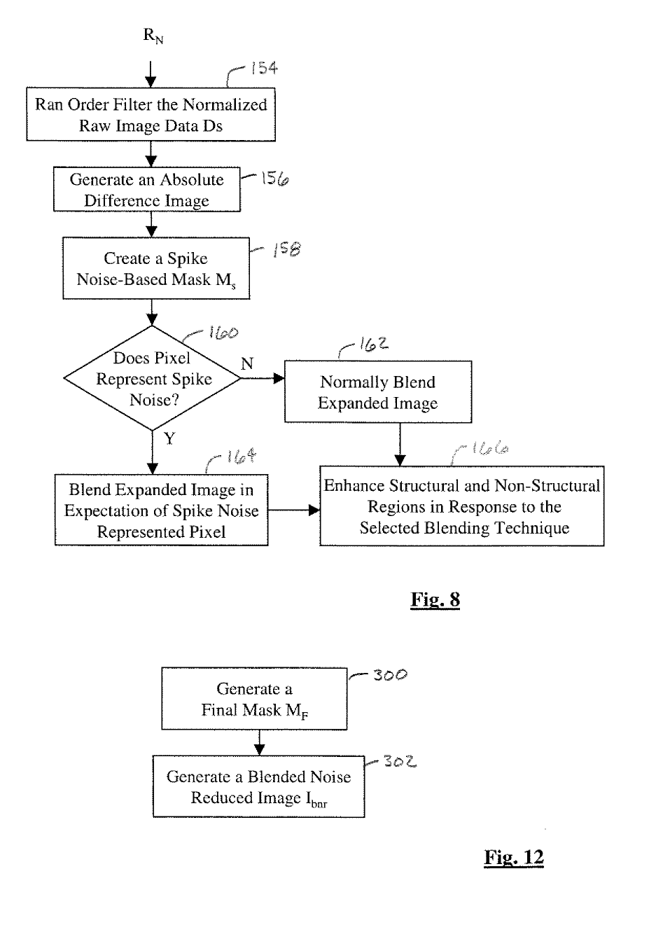

Referring now to step 108 of FIG. 4 and to the logic flow diagram of FIG. 8.ln step 108, the normalized data R_{N} is structure dependent smooth filtered. The tasks performed in step 108 are shown in and described with respect to FIGS. 8-10.

Referring to FIG. 8, in step 150 the normalized data R_{N} is filtered via the processor 28. In order to account for and reduce the spike noise in the ultimate image, the spike noise in the input images are characterized. The processor 28 may shrink or sub-sample the normalized data R_{N} by a shrink parameter. As will be appreciated by those skilled in the art, such shrinking may be accomplished by various sub-sampling techniques, including a pixel averaging, in which the digital values representative of intensities at each pixel are read and the image is shrunk by some factor X which is generally greater than 1. In a present embodiment, a 2×2 or 3×3 boxcar filter may be applied to obtain a non-overlapping average. Multi-dimensional factors may also be employed, such as 2×3 or 3×2 filters. A multi-dimensional factor must be greater than 1 in at least one of the dimensions, such as in a 3×1or a 1×3 filter. To obtain non-overlapping averages, the pixels of the image may be mirrored at the boundaries when needed.

In step 154, the normalized data R_{N} is rank order filtered. For characterization of spike noise, the input image is processed through a rank-order filter (not shown). The extent of the rank-order filtering may depend upon the definition of a spike for a particular image, imaging modality, and the like. For example, if spike noise is defined as a single pixel, then a 3×3 rank-order filtering kernel may suffice. As will be appreciated by those skilled in the art, for rank-order filtering each pixel of interest is replaced by a value selected from a rank-ordered listing of neighboring pixels. Thus, for a 3×3 kernel, 9 pixels, including the pixel of interest are rank-ordered and one of the values is selected to replace the pixel of interest value in the rank-ordered filtered image. Other kernel sizes may, of course, be utilized. In one embodiment, the pixel of interest is replaced by a value near but necessarily in the middle of the range of neighboring pixel values.

In step 156, an absolute difference image is computed based upon the rank-order filtered image. The absolute difference image is computed by subtracting pixel values from the rank-order filtered image from correspondingly located pixel values in the input image. The absolute difference image may include relatively low values owing to the neighborhoods considered in the rank-ordering of step 154 performed.

In step 158, a spike noise-based mask Mₛ is created having the same dimensions as the input image, the rank-order filtered image, and the absolute difference image. In this process, a histogram of the values contained in the absolute difference image is first compiled. A threshold intensity value on the histogram is selected based upon some criterion, such that it is more likely that the spike noise differences are above the intensity value. The threshold intensity value may depend upon the particular image characteristics and the imaging modality. By way of example, the threshold intensity value may be set to a value that is a percentage of counts of the first non-zero difference bin of the histogram.

The spike noise mask Mₛ may be developed such that the pixels of the input image are tagged as spike noise. Blending of the input image with the filtered and expanded image data may be governed by the spike noise mask Mₛ.

The spike noise mask Mₛ may be a binary or multi-level mask. To create such a mask, a multi-level threshold criterion may be used having many levels of likelihood of spike noise. By way of example, six levels in the spike noise mask Mₛ may be created by using difference percentage multipliers with the base account described above. Pixels within these multiple levels may be identified the spike noise mask Mₛ as relatively more or less likely to represent spike noise. The pixels at the various levels will then be associated with different blending parameters as described below.

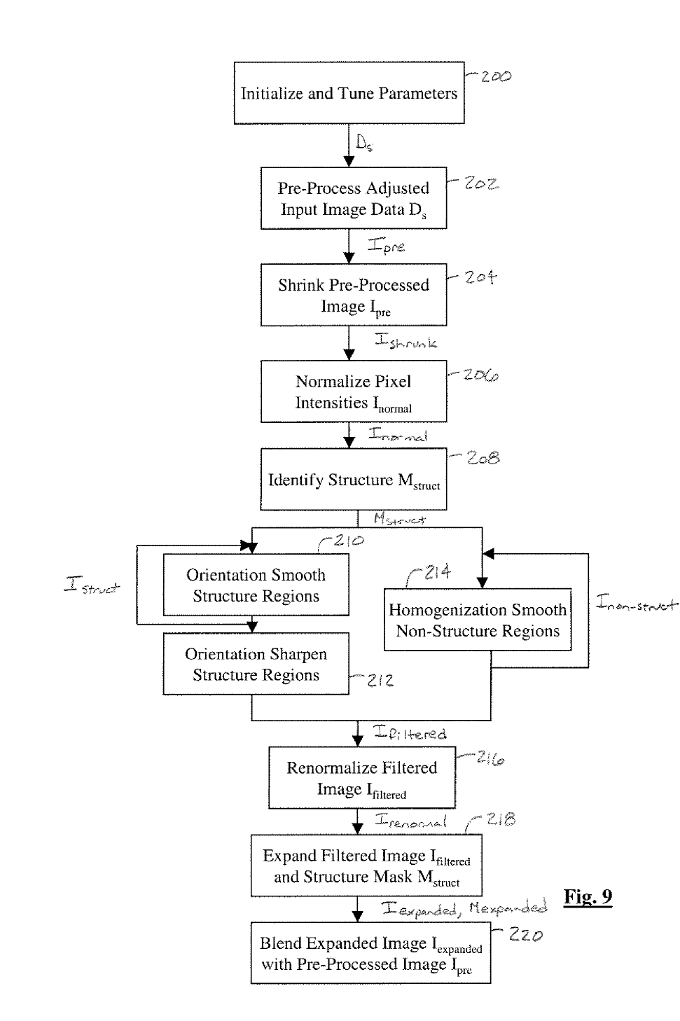

In step 160, the processor 28 determines whether each individual pixel of the input image is likely to represent spike noise. As noted above, this likelihood may be based upon a binary mask or a multi-level mask. Where a pixel is not identified as likely to represent spike noise, normal blending with the expanded image I_{expanded}, generated in step 218 of FIG. 9, may be performed as indicated at step 162. However, where the pixel is likely to represent spike noise, the expanded image I_{expanded} may be blended differently, as indicated at step 164. In step 166, structural and non-structural regions of the normalized data R_{N} are enhanced in response to the selected blending technique determined in steps 160-164.

Referring now to FIG. 9, a logic flow diagram illustrating a method of enhancing structural and non-structural regions in response to the selected blending technique, as depicted in step 166 of the method of FIG. 8. The logic flow diagram of FIG. 9 illustrates a sequence of processing stages applied to image data and as a progression of modified images resulting from the stages of the present techniques. The structural regions 62 and non-structural regions 76 are identified and enhanced in accordance with summarized control logic.

In step 200, the control logic routine begins with the initialization and tuning of parameters, either default or operator selected, and employed in the image enhancement process. This initialization typically includes the amount of shrinking, the interpolation type, and the parameters specific to noise reduction, i.e. thresholds related to focus, edge determination, and blending.

Where desired, entry or selection of some of these parameters may be prompted via the input device 38, allowing the operator to select between several parameter choices, such as the desired field-of-view of an image. Assignment of certain downstream parameters may then be automated in response to the operator-selected parameters. For example, the parameter associated with the amount of shrinking to be used in processing, i.e. the shrink factor, may be set automatically in response to the operator's selection of a field-of-view which directly determines the amount of area described by a pixel. For example, in one embodiment, the shrink factor may be set to 1 for images of size 256×256 or smaller, 2 for images larger than 256×256 but less than or equal to 512×512, and 4 for images larger than 512×512.

Automated determination of this shrink factor, or other initialization parameters, in response to operator-selected parameters, allows the production of uniform images that possess the same appearance or quality, even when different fields of view are selected. In this manner, an operator need only select the field-of-view and the processing circuitry 28 will assign the other appropriate parameters to produce images of uniform quality and appearance. While the assignment of parameters, such as the shrink factor, need not be automated, thereby allowing the operator to assign all image enhancement parameters, it is generally desirable to provide such automation to enhance the uniformity of the filtering process and to minimize the time and effort required of the operator.

In step 202, the processor 28 pre-processes the adjusted input image or adjusted smoothed normalized data Dₛ. Pre-processing of the input image data Dₛ typically involves augmenting the size of the image to prevent the loss of data during the subsequent shrinking of the image. In particular, the appropriate boundaries of the input image Dₛ are padded by mirroring the boundary image data in order to allow the subsequent shrink function to process and produce integer values. The result of pre-processing is a pre-processed image, represented as Iₚᵣₑ.

In step 204, the pre-processed image Iₚᵣₑ is then shrunk by the processor 28 using a sub-sampling technique. The shrinking of the pre-processed image Iₚᵣₑ may be accomplished by various sub-sampling techniques, including pixel averaging, in which the digital values, representative of intensities at each pixel, are read and then the image is shrunk by some shrink factor X which is generally greater than one. In the preferred embodiment, a 2×2 or 3×3 boxcar filter may be applied to obtain a non-overlapping average. Multi-dimensional factors may also be employed, such as 2×3 or 3×2 filters. A multi-dimensional factor must be greater than one in at least one of the dimensions, such as in 3×1 or 1×3 filters. In order to obtain a non-overlapping average, pixels may be mirrored at the boundaries when needed. A shrunken image Iₛₕᵣᵤₙₖ is the product of the sub-sampling technique.

In step 206, the processor 28 normalizes the image values acquired for the pixels defining the shrunken image Iₛₕᵣᵤₙₖ to generate a normalized image Iₙₒᵣₘₐₗ. Digital values representing intensities at each pixel are read and scaled over a desired dynamic range. For example, the maximum and minimum intensity values in the image may be determined, and used to develop a scaling factor over the full dynamic range of the display 32. Moreover, a data offset value may be added to or subtracted from each pixel value to correct for intensity shifts in the acquired data. The normalized image Iₙₒᵣₘₐₗ includes pixel values filtered to span a desired portion of a dynamic range, such as 12 bits, independent of variations in the acquisition circuitry or subject.

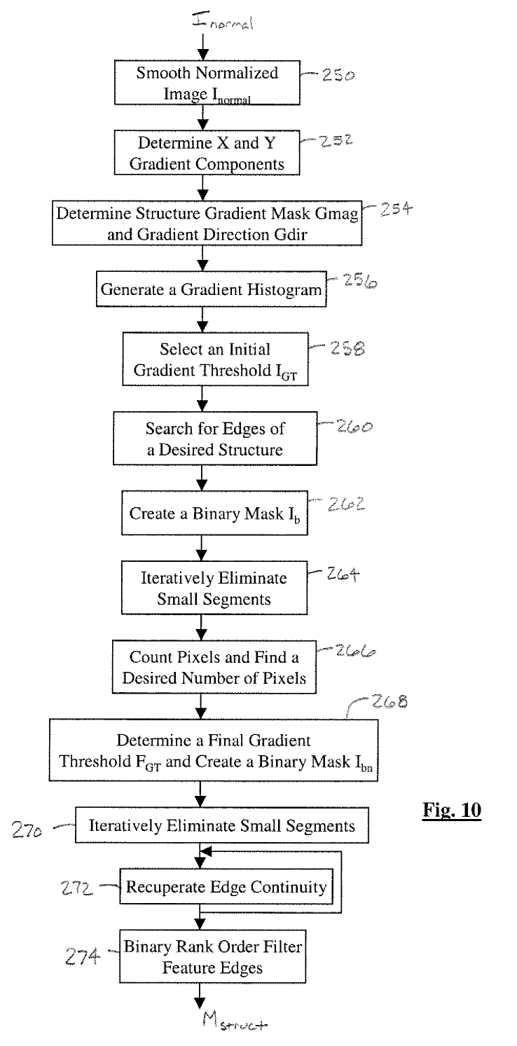

In step 208, the processor 28 executes a predetermined logic routine for identifying the structure 62 within the normalized image Iₙₒᵣₘₐₗ, as defined by data representative of the individual pixels of the image. Exemplary steps for identifying the structure in accordance with the present technique are described below with reference to FIG. 10. The structure identified in step 208 is used to generate a structure mask M_{struct}.

Referring now to FIG. 10, a logic flow diagram illustrating a method of identifying structures in the operation of the method of FIG. 9 is shown in accordance with an embodiment of the present invention.

In step 250, a blurred or smoothed version of the normalized image Iₙₒᵣₘₐₗ is preferably formed. The structure identification process begins with this smoothed version such that structural components of the image may be rendered more robust and less susceptible to noise. While any suitable smoothing technique may be employed, in the present embodiment, a box-car smoothing technique is used, wherein a box-car filter smoothes the image by averaging the value of each pixel with values of neighboring pixels. As will be appreciated by those skilled in the art, a computationally efficient method for such filtering may be implemented, such as employing a separable kernel, which is moved horizontally and vertically along the image until each pixel has been processed.

In step 252, X and Y gradient components for each pixel are computed based upon the smoothed version of the normalized image Iₙₒᵣₘₐₗ. While several techniques may be employed for this purpose, one technique includes the use of 3×3 Sobel modules or operators. The modules are used for identifying the X gradient component and the Y gradient component of each pixel. The modules are superimposed over the individual pixel of interest, with the pixel of interest situated at the central position of the 3×3 module. The intensity values located at the element locations within each module are multiplied by the scalar value contained in the corresponding element, and the resulting values are summed to arrive at the corresponding X and Y gradient components.

In step 254, the gradient magnitude Gmag and the gradient direction Gdir are determined in response to the X and Y gradient components. The gradient magnitude Gmag for each pixel is equal to the higher of the absolute values of the X and Y gradient components for the respective pixel. The gradient direction is determined by finding the arctangent of the Y component divided by the X component. For pixels having an X component equal to zero, the gradient direction is assigned a value of π/2. The values of the gradient magnitudes and gradient directions for each pixel are saved in the memory circuit 26.

It should be noted that alternative techniques may be employed for identifying the X and Y gradient components and for computing the gradient magnitudes and directions. For example, those skilled in the art will recognize that in place of the Sobel gradient modules, other modules such as the Roberts or Prewitt operators may be employed. Moreover, the gradient magnitude Gmag may be assigned in other manners, such as a value equal to the sum of the absolute values of the X and Y gradient components. The gradient magnitude Gmag is the structure gradient mask depicted as being generated in box 110 of FIG. 4.

In step 256, a gradient histogram is generated in response to the above-stated gradient values. The histogram is used to identify a gradient threshold value G_{TV} for separating structural components of the image from non-structural components. The gradient threshold value G_{TV} is set at a desired gradient magnitude level. The gradient threshold value G_{TV} is depicted as being generated in box 112 of FIG. 4. Pixels having gradient magnitudes at or above the gradient threshold value G_{TV} are considered to meet a first criterion for defining structure in the image, while pixels having gradient magnitudes lower than the threshold value G_{TV} are initially considered non-structure. The gradient threshold value G_{TV} is used to separate structure from non-structure and may be set by an automatic processing or “autofocus” routine. However, it should be noted that the gradient threshold value G_{TV} may also be set by operator intervention or may be over-ridden by the operator to provide specific information in the resulting image.

In step 258, an initial gradient threshold value I_{GT} is selected. This initial gradient threshold I_{GT}, is set to a value corresponding to a percentile of the global pixel population, such as 30%. Once the desired percentile value is acquired, the corresponding gradient magnitude Gmag is equal to the value assigned to the initial gradient threshold I_{GT}.

In step 260, a search is performed for edges of the desired structure. The edge search proceeds by locating the pixels having gradient magnitudes greater than the initial gradient threshold I_{GT} and considering a 5×5 pixel neighborhood surrounding the relevant pixels of interest. Within the 5×5 pixel neighborhood of each pixel of interest, pixels having gradient magnitudes above the initial gradient threshold I_{GT} and having directions which do not differ from the direction of the pixel of interest by more than a predetermined angle are counted. In the present embodiment, an angle of 0.35 radians is used in this comparison step. When the 5×5 neighborhood count is greater than a preset number the pixel of interest is identified as a relevant edge pixel.

In step 262, a binary mask image I_{b} is created wherein pixels identified as relevant edge pixels in step 260 are assigned a value of 1, while all other pixels are assigned a value equal to zero.

In step 264, small or noisy segments identified as potential candidates for structure are iteratively eliminated using techniques known in the art.

In step 266, the number of pixels remaining in the binary mask image I_{b} are counted. While the resulting number may be used to determine a final gradient threshold F_{GT}, it has been found that a convenient method for determining a final gradient threshold for the definition of structure includes the addition of a desired number of pixels to the resulting pixel count. For example, a value of 4,000 may be added to the binary mask count to arrive at a desired number of pixels in the image structure definition. The desired number of pixels may be set as a default value, or may be modified by an operator. In general, a higher additive value produces a sharper image, while a lower additive value produces a smoother image. This desired number of pixels, referred to in the present embodiment as the “focus parameter”, may be varied to redefine the classification of pixels into structures and non-structures.

In step 268, with the desired number of structure pixels thus identified, a final gradient threshold F_{GT} is determined based upon the histogram in step 256. In particular, the population counts for each gradient magnitude value of the histogram are summed. Once the desired number of structural pixels is reached (i.e., the number of pixels counted at block 266 plus the focus parameter), the corresponding gradient magnitude value is identified as the final gradient threshold F_{GT}. The final gradient threshold F_{GT} is then scaled through multiplication by a value, which may be automatically determined or which may be set by a user. For example, a value of 1.9 may be employed for scaling the final gradient threshold F_{GT}, depending upon the image characteristics and the type and features of the structure viewable in the image. The use of a scalable threshold value also enables the technique to be adapted easily and quickly to various types of images, such as for MR image data generated in systems with different field strengths.

Based upon the scaled final gradient threshold, a new binary mask I_{bn} is defined by assigning pixels having values equal to or greater than the final gradient threshold F_{GT} a value of 1, and all other pixels a value of zero.

In step 270, the resulting binary mask I_{bn} is filtered to eliminate small, isolated segments in a process identical to that described above with respect to step 264. However, in step 270 rather than a four-connected neighborhood, an eight-connected neighborhood (i.e., including pixels having shared edges and corners bounding the pixel of interest) is considered in the index number merger steps.

In step 272, certain isolated regions may be recuperated to provide continuity of edges and structures. When a pixel in the gradient image is above a second gradient threshold and is connected or adjacent a pixel which is above the final gradient threshold F_{GT}, the corresponding pixel in the binary image is changed from a 0 value to a value of 1. The value of the second gradient threshold may be set to a desired percentage of the final gradient threshold F_{GT}, and may be determined empirically to provide the desired degree of edge and structure continuity. Step 272 may be performed recursively to determine an initial classification of the pixels.

In step 274, the feature edges identified through the previous processes, representative of candidate structures in the image, are binary rank order filtered to generate the structure mask M_{struct}. While various techniques may be employed for this enhancing identified candidate structures, it has been found that the binary rank order filtering provides satisfactory results in expanding and defining the appropriate width of contiguous features used to define structural elements.

Referring again to FIG. 9, in step 210 the structure mask M_{struct} is used to identify structure, which is then orientation smoothed. The processor 28 in filtering or smoothing the normalized data R_{N} serves to identify, process, and differentiate structural features and non-structural features or regions. Various known techniques may be employed for this orientation smoothing. However, in the described embodiment, dominant orientation smoothing may be carried out, which tends to bridge gaps between spans of structure, or local orientation smoothing may be employed to avoid such bridging. Orientation smoothing transforms the normalized image Iₙₒᵣₘₐₗ to a filtered structure image I_{struct}, which is further refined by subsequent processing. In step 212, after the identified structure has been orientation smoothed, the structure regions are then orientation sharpened to further refine the filtered structure image I_{struct}.

In step 214, the image processing circuit 24 performs homogenization smoothing on non-structure regions of the normalized image Iₙₒᵣₘₐₗ. This isotropic smoothing blends features of non-structural regions into the environment surrounding the identified structure to produce a filtered non-structure image I_{non-struct}. The filtered non-structure image I_{non-struct}, along with the filtered structure image I_{struct}, are the components of the composite filtered image I_{filtered}. Steps 210 and 214 may be iteratively performed.

In step 216, the filtered image I_{filtered} is renormalized, based upon the post-filtering pixel intensity values and the original normalized intensity range, to produce a renormalized image Iᵣₑₙₒᵣₘₐₗ.

In step 218, both the structure mask M_{struct} and the renormalized image Iᵣₑₙₒᵣₘₐₗ are expanded by the same factor by which pre-processed image Iₚᵣₑ was shrunk or sub-sampled to produce an expanded structure mask M_{expanded} and an expanded image I_{expanded}, both of which are the same dimensions as the pre-processed image Iₚᵣₑ.

In step 220, texture present in the pre-processed image Iₚᵣₑ is blended back into the expanded image I_{expanded}, to produce a blended image I_{blended}. The blending process of step 220 utilizes the expanded structure mask M_{expanded} to allow differential texture blending of structure and non-structure regions. The blended image I_{blended} is the structure dependent noise filtered image depicted in step 114 of FIG. 4.

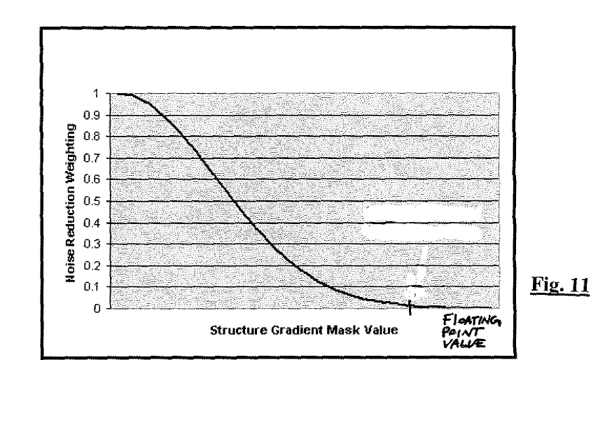

Referring again to FIG. 4,in step 116 an adjusted gradient threshold value G_{TA} is generated in response to the gradient threshold value G_{TV} and a gradient threshold scalar G_{TS}. The gradient threshold scalar G_{TS} may be user selected, as sample of which is shown in the plot of FIG. 11. The adjusted gradient threshold value G_{TA} is set equal to the multiplied result of the gradient threshold value G_{T} and the gradient threshold scalar G_{TS}.

In step 118, weight function values are determined in response to the structure gradient mask Gmag and the adjusted gradient threshold value G_{TA}. A gradient level masking look-up table or curve is utilized to generate the weight function values. The weight function values are values between zero and one. When the value of the structure gradient mask is less than the adjusted gradient threshold value G_{TA}, a noise reduction weighting value corresponding to a respective point on the gradient level masking plot is assigned. When the value of the structure gradient mask is equal to or greater than the adjusted gradient threshold value G_{TA}, a noise reduction weighting value corresponding to that of the threshold value G_{TA} is assigned.

In step 119, the smoothed normalized raw image data generated in step 104 is used to generate a count based weighting mask M_{bcb}. The values of the weighting mask M_{bcb} are determined in response to the smoothed data Dₛ, a low count flat value LowCountFlat, a transition value T, and the weight function values W_{f}. The values of the weighting mask M_{bcb} are represented by equation 1.
M_{bcb}=((Dₛ−LowCountFlat)/T)×(1−W_{f}) (1)

The low count flat value LowCountFlat is user selected.

The transition value T is equal to LowCountLimit minus LowCountFlat, where LowCountLimit is user selected and is higher than LowCountFlat.

In step 120, a conditioned structure mask M_{cs} is generated. The conditioned structure mask M_{cs} is generated in response to the weight function values W_{f} and the counts-based weighting mask M_{bcb}. The values of the conditioned structure mask M_{cs} are conditionally determined using equations 2-4.
M_{cs}=W_{f} if Dₛ<=LowCountFlat (2)
M_{cs}=M_{bcb} if LowCountFlat<Dₛ<LowCountLimit (3)
M_{cs}=1 if Dₛ>=LowCountLimit (4)

In step 122, the normalized data R_{N} and the structure dependent noise filter data I_{blended} are blended in response to the multiplied result of the counts-based mask M_{cb} and the conditioned structure mask M_{cs}. The tasks performed in step 122 are described with respect to FIG. 12.

Referring now to FIG. 12, a logic flow diagram illustrating a method of performing a blending operation for step 122 of the method of FIG. 4 is shown.

In step 300, the counts-based mask M_{cb} and the conditioned structure mask M_{cs} are multiplied to form a final mask M_{F}. In step 302, a blended noise reduced image I_{bnr} is generated utilizing equation 5.
I_{bnr}=[M_{F}×B×I_{blended}]+[1−(M_{F}×B)]×R_{N} (5)

The blended noise reduced image I_{bnr} is high frequency noise reduced in low count regions, but since the counts of the raw data R have been considered low count areas are not filtered to such an extent to eliminate structures that are visible and have a relatively low count.

Referring again to FIG. 4, in step 124 the blended noise reduced image I_{bnr} is smoothed to form a smooth blended noise reduced image I_{sbnr}. The blended noise reduced image I_{bnr} may be smoothed using a similar technique as that used in step 104, using a low pass filter, or using some other technique known in the art.

In step 126, the values of the blended noise reduced image I_{bnr} are intensity matched with the values in the normalized raw image data Dₛ to match low frequencies therein. The values may be intensity matched using equation 6 to generate a final noise reduced image I_{F}.
I_{F}=I_{bnr}×[LPF[Dₛ]/(LPF[I_{sbnr}]+0.1)] (6)

LPF refers to a low pass filter function that is used to match low frequencies. Different low pass functions (e.g., a box-car filter) can be used for this purpose and the parameters controlling the low pass filter function can be used to vary the amount of matching. The above-described steps are meant to be an illustrative example; the steps may be performed synchronously, sequentially, simultaneously, or in a different order depending upon the application.

The present invention provides a method of adaptively reducing noise within an x-ray image. The present invention achieves a significant amount of noise reduction while minimizing contrast degradation in high signal-to-noise regions that need only minimal noise reduction based on the detected and or processed image intensities. Noise reduction is suppressed in low signal-to-noise regions that have significant “structure”, in order to avoid degrading clinical detail.

The above use of a detected signal in conjunction with image intensities after display processing ensures that the detection physics as well as the perceptual effects of display processing, such as edge enhancement, contrast enhancement, and others known in the art, are accounted for to achieve a desired noise reduction.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

1. A method of adaptively reducing noise within an x-ray image comprising:
receiving raw data from an x-ray detector representing a detected x-ray signal from an object;
generating a counts-based modulation mask in response to said raw data;
generating a structure dependent noise filtered image in response to said raw data; and
generating a noise reduced image in response to said counts-based modulation mask and said structure dependent noise filtered image.

2. A method as in claim 1 further comprising:
generating a structure gradient mask in response to said raw data; and
generating said noise reduced image in response to said structure gradient mask.

3. A method as in claim 1 further comprising:
normalizing said raw data in response to a dose-sensitivity setting of said x-ray detector; and
generating said noise reduced image in response to said normalization.

4. A method of adaptively reducing noise within an x-ray image having a plurality of pixels comprising:
receiving raw data representing a detected x-ray signal from an object;
generating a counts-based modulation mask in response to said raw data;
generating a structure gradient mask in response to said raw data; and
generating a noise reduced image in response to said counts-based modulation mask and said structure gradient mask.

5. A method as in claim 4 further comprising:
executing a structural analysis of said raw data to derive a structure dependent noise filtered image; and
generating said noise reduced image in response to said structure dependent noise filtered image.

6. A method as in claim 4 wherein said structure gradient mask is generated in response to execution of a structural analysis of said raw data.

7. A method as in claim 4 wherein generating said noise reduced image comprises:
generating a conditioned structure mask in response to said raw data; and
blending said counts-based modulation mask and said conditioned structure mask to generate a blended image having a plurality of blended values.

8. A method as in claim 7 wherein blending comprises modulating said blending values at each pixel location of said plurality of pixels in response to said counts-based modulation mask and said conditioned structure mask.

9. A method as in claim 4 further comprising:
executing a structural analysis of said raw data to derive a structure dependent noise filtered image and to generate a conditioned structure mask;
blending said raw data, said counts-based modulation mask, said structure dependent noise filtered image, and said conditioned structure mask to generate a blended image; and
generating said noise reduced image in response to said blended image.

10. A method as in claim 9 wherein said blended image is generated in response to a final mask defined as the multiplication of said counts-based modulation mask and said conditioned structure mask.

11. A method as in claim 10 wherein said blended image is generated in response to the multiplication of said structure dependent noise filtered image, said final mask, and a predetermined blend parameter.

12. A method as in claim 10 wherein said blended image is generated in response to the multiplication of said raw data by a subtracted result of one minus a multiplied result of a predetermined blend parameter and said final mask.

13. A method as in claim 4 further comprising:
generating a conditioned structure mask in response to said structure gradient mask; and
generating said noise reduced image in response to said conditioned structure mask.

14. A method as in claim 13 wherein said conditioned structure mask is generated in response to a low count modulation of said raw data and a weighted function.

15. A method as in claim 13 wherein generating said conditioned structure mask comprises:
generating a gradient threshold value;
generating a gradient threshold scaler;
generating a weighted function in response to said structure gradient mask, said gradient threshold value, and said gradient threshold scaler; and
generating said conditioned structure mask in response to said raw data and said weighted function.

16. A method as in claim 13 wherein said conditioned structure mask is generated in response to a low count limit and a low count flat.

17. A method as in claim 4 wherein said counts-based modulation mask represents a weighting function on absolute detected intensities comprising effects of imaging system gain.

18. A method as in claim 4 wherein generating said noise reduced image comprises:
generating a plurality of blended values in response to said counts-based modulation mask and said structure gradient mask; and
intensity matching said plurality of blended values.

19. A method as in claim 18 wherein intensity matching said plurality of blended values comprises equalizing intensity levels of said blended image.

20. A method as in claim 4 wherein generating a counts-based modulation mask comprises assigning each pixel location of the plurality of pixels a weight in response to a detected signal level at that location.

21. A method as in claim 20 wherein said weight is assigned in response to a count modulation curve.

22. A method as in claim 21 wherein said count modulation curve is selected from a group of count modulation curves.

23. A method as in claim 22 wherein said group of count modulation curves comprises a low noise reduction curve, a medium noise reduction curve, and a high noise reduction curve.

24. A method as in claim 20 wherein said count modulation curve comprises at least one segment selected from a primary offset segment, a primary roll-off segment, secondary offset segment, a secondary roll-off segment, primary offset segment with constant weighting, a primary roll-off segment with decreasing weighting, secondary offset segment with constant weighting, and a secondary roll-off segment with decreasing weighting.

25. A method as in claim 20 wherein at least a portion of said count modulation curve is in a form of a Gaussian distribution.

26. A method as in claim 4 wherein generating said noise reduced image comprises:
generating blended values in response to said counts-based modulation mask and said structure gradient mask; and
generating said noise reduced image in response to said blended values, smoothing of said raw data, and smoothing of said blended values.

27. A computer processing system for facilitating signal-adaptive noise reduction in x-ray images comprising:
an input device receiving raw data representing a detected x-ray signal from an object; and
a processor receiving said raw data and generating a counts-based modulation mask;
said processor generating a noise reduced image in response to said counts-based modulation mask.

28. A system as in claim 27 further comprising:
a filter generating a structure dependent noise filtered image in response to said raw data;
said processor generates a structure gradient mask in response to said raw data and generates said noise reduced image in response to said raw data, said structure dependent noise filtered image, and said structure gradient mask.

29. A system as in claim 28 wherein generating said noise reduced image comprises:
deriving a conditioned structure mask in response to said structure gradient mask; and
blending said raw data, said counts-based modulation mask, said structure dependent noise filtered image, and said conditioned structure mask.

30. An x-ray system for adaptively reducing noise within an x-ray image comprising:
an x-ray source generating x-rays;
an x-ray detector receiving said x-rays and generating raw data; and
a controller generating a counts-based modulation mask, a structure gradient mask, and a structure dependent noise filtered image in response to said raw data, and generating a noise reduced image in response to said raw data, said counts-based modulation mask, said structure dependent noise filtered image, and said structure gradient mask.

31. A system as in claim 30 wherein generating said noise reduced image comprises:
deriving a conditioned structure mask in response to said structure gradient mask; and
blending said raw data, said counts-based modulation mask, said structure dependent noise filtered image, and said conditioned structure mask.
